(19) United States
(12) Patent Application Publication
(10) Pub. No.: US 2026/0279603 A1
(43) Pub. Date: Sep. 17, 2026

(54) CENTRAL SOLENOID (CS) RETAINING STRUCTURES AND RELATED TECHNIQUES

(71) Applicants: Massachusetts Institute of Technology, Cambridge, MA (US); Commonwealth Fusion Systems LLC, Devens, MA (US)

(72) Inventors: Alexey RADOVINSKY, Cambridge, MA (US); Justin Robert CARMICHAEL, Bedford, MA (US); Christopher CRAIGHILL, Groton, MA (US)

(73) Assignees: Massachusetts Institute of Technology, Cambridge, MA (US); Commonwealth Fusion Systems LLC, Devens, MA (US)

(21) Appl. No.: 19/473,307

(22) PCT Filed: Apr. 5, 2024
(86) PCT No.: PCT/US2024/023247

§ 371 Date: Oct. 7, 2025

Related U.S. Application Data
(60) Provisional application No. 63/494,813, filed on Apr. 7, 2023.

(51) Int. Cl. G21B 1/05; G21B 1/11

(52) U.S. Cl. CPC G21B 1/057; G21B 1/11

(57) ABSTRACT

Described are central solenoid (CS) retaining structures and related assembly techniques. Also described are assembly techniques for a tokamak fusion reactor.

### CROSS-REFERENCE TO RELATED APPLICATIONS

This application claims the benefit under 35 U.S.C. § 119 of U.S. Provisional Patent Application No. 63/494,813 filed on Apr. 7, 2023, which is hereby incorporated by reference herein in its entirety.

### STATEMENT REGARDING FEDERALLY SPONSORED RESEARCH

N/A

### BACKGROUND

Fusion energy is a possible solution to the need for clean energy. Fusion energy is safe, energy-dense and produces no greenhouse gas emissions. In a fusion reaction, light atomic nuclei such as hydrogen, are combined to form heaver nuclei, such as helium, while producing energy.

### SUMMARY OF DISCLOSED EMBODIMENTS

Described are central solenoid (CS) retaining structures and related assembly techniques. Also described are assembly techniques for a tokamak fusion reactor. In embodiments, a CS retaining structures includes a lower structural plate configured to lock into one or more recesses provided in one or more TF coil cases.

The concepts, systems, structures and techniques described herein enable the use of high temperature superconducting (HTS) magnets for inductive plasma-drive in tokamak devices.

### DESCRIPTION OF THE SEVERAL VIEWS OF THE DRAWINGS

The manner and process of making and using the disclosed embodiments may be appreciated by reference to the figures of the accompanying drawings. It should be appreciated that the components and structures illustrated in the figures are not necessarily to scale, emphasis instead being placed upon illustrating the principals of the concepts described herein. Like reference numerals designate corresponding parts throughout the different views. Furthermore, embodiments are illustrated by way of example and not limitation in the figures, in which:

FIG. 1A is a perspective view of a tokamak fusion reactor;

FIG. 1B is an isometric cross-sectional view of a one-quarter portion of a tokamak fusion reactor illustrating Toroidal Field (TF) and Central Solenoid (CS) magnets and a first embodiment of a CS retaining structure;

FIG. 1C is a bottom view of the portion of the tokamak fusion reactor shown in FIG. 1B;

FIG. 1D is a top view of a bucked design of a tokamak fusion reactor when the TF coils are not energized;

FIG. 1E is a top view of the bucked design of FIG. 1D when the TF coils are energized;

FIG. 2 is an isometric view of a deformed TF coil case;

FIG. 3A is an isometric view of a first embodiment of a CS retaining structure;

FIG. 3B is an isometric cross-sectional view of a portion of the CS retaining structure of FIG. 3A;

FIG. 4 is an isometric view of a second embodiment of a CS retaining structure;

FIG. 5A is an axonometric view of a third embodiment of an assembled stand-alone CS retaining structure;

FIG. 5B is an exploded view of the CS retaining structure of FIG. 5A;

FIG. 5C is a cross-sectional view taken across lines 5C-5C of the assembled CS retaining structure of FIG. 5A;

FIG. 5D is a cross-sectional view of a portion of the CS retaining structure taken across lines 5D-5D of FIG. 5C;

FIG. 5E is an enlarged view of a portion of the CS retaining structure shown in FIG. 5D;

FIG. 6 is an axial cut of an embodiment of a CS retaining structure installed on a CS inside a TF coil assembly;

FIGS. 7A-7H are a series of top views illustrating assembly of a lower structural plate comprised of multiple segments within a TF coil assembly; and

FIG. 8 is an axial cut of an embodiment of a CS retaining structure installed on the inside a TF coil assembly.

### DETAILED DESCRIPTION

Before describing the broad concepts, devices, systems and techniques sought to be protected herein, some introductory concepts are explained.

Magnetic confinement is an approach to generate fusion power that uses magnetic fields to confine a plasma to produce conditions under which the plasma will undergo fusion. Very high plasma temperatures, on the order of 150 million° C., are needed to initiate fusion reactions. The plasma may be heated through operation of the magnetic fields and using external heating methods. Magnetic confinement of a plasma is challenging, as turbulence, instabilities, and other effects within the plasma can quickly reduce the efficiency of the fusion reaction, or even stop it completely.

A fusion reactor design known as a tokamak is one approach to magnetic confinement that seeks to address the problematic instabilities that can result in the plasma during heating and/or during fusion reactions. In a tokamak, the plasma is confined in a toroid, and instabilities in the plasma are controlled by arranging magnetic fields to cause particles of the plasma to transit between the inner and outer sides of the toroid multiple times per orbit. To control the plasma in a tokamak, magnets are used to create toroidal and poloidal fields that shape and position the plasma within the toroid, as well as drive motion of the plasma around the toroid.

No previous magnetic confinement fusion device has demonstrated a gain greater than 1, which is a necessary step to commercializing magnetic confinement fusion devices as a viable energy source. The fusion performance of a tokamak can be improved by increasing the magnetic field strength or increasing the size of the tokamak. Increasing the size of a tokamak may require a great deal of infrastructure and lead to high costs. Accordingly, it would be desirable to keep the size of a tokamak reactor small while increasing the magnetic field to improve performance. Magnets capable of achieving high magnetic field strengths have been demonstrated using cryogenically cooled high-temperature superconductor (HTS), which may be in the form of HTS tape.

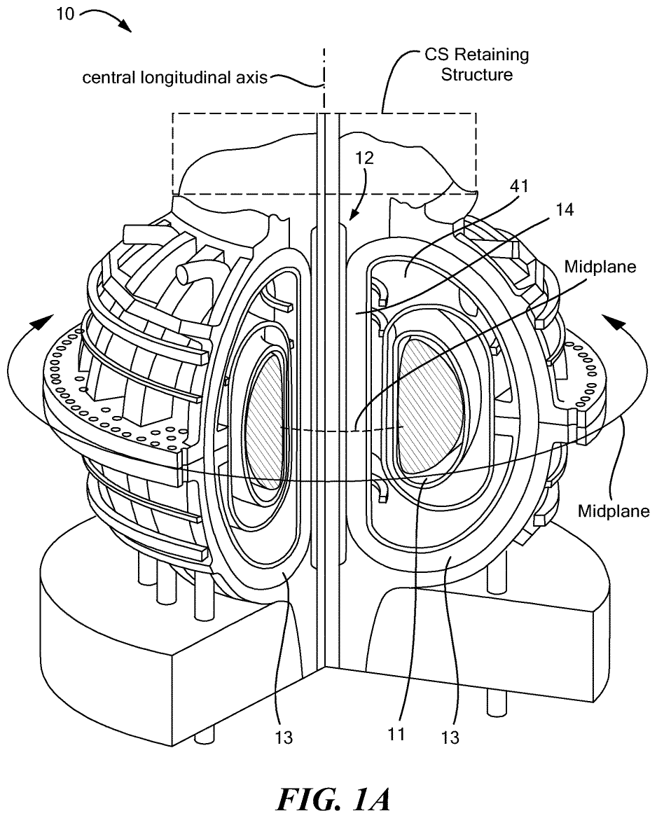

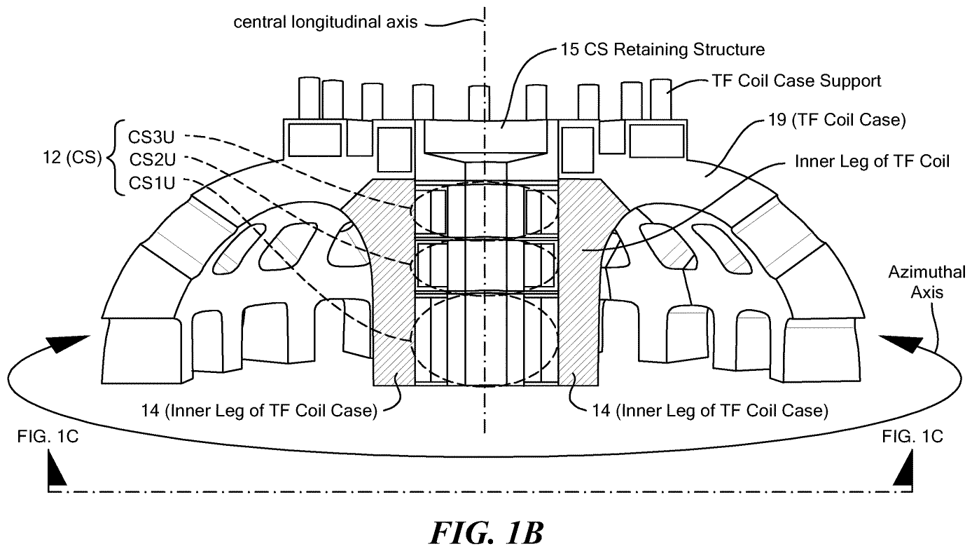

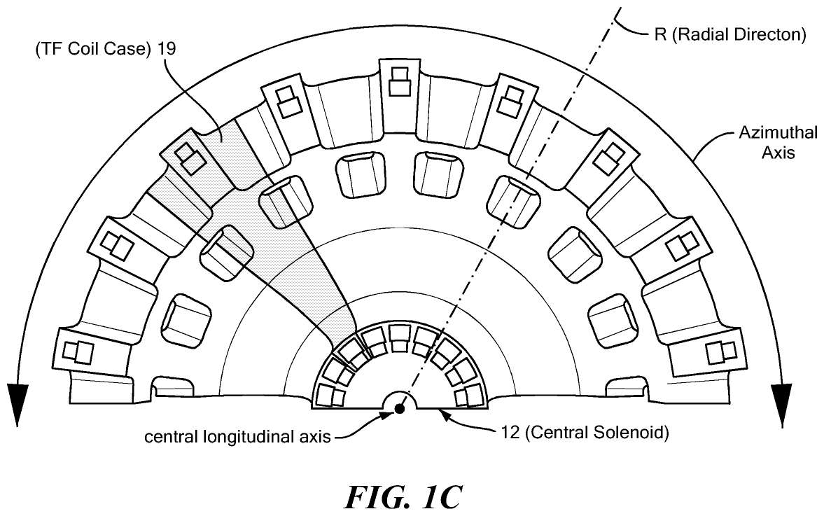

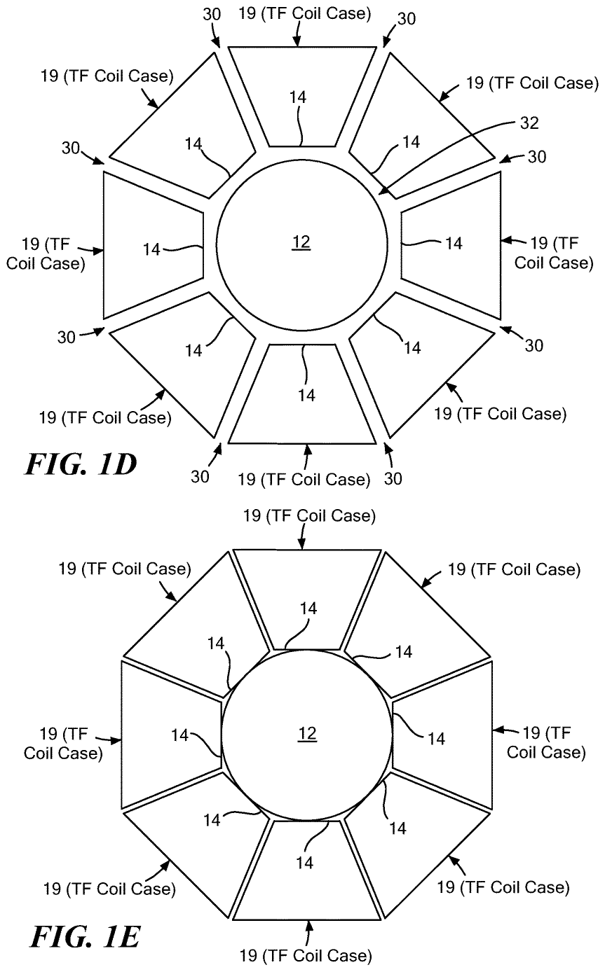

FIG. 1A is a perspective view of a portion of a tokamak fusion reactor 10 comprising a vacuum vessel 11. The vacuum vessel 11 is disposed in a radiation shield (or “shield tank”) 41. Vacuum vessel 11 and radiation shield 41 are disposed about a central solenoid (CS) 12. Toroidal field (TF) coils 13 are disposed about CS 12 and a CS retaining structure is disposed over the CS and TF coils.

The CS retaining structure is here shown in phantom and example CS retaining structures will be described herein below in conjunction with FIGS. 1B, 1C, and 3A-7H. Suffice it here to say one purpose of the CS retaining structure is to mechanically stabilize the CS so as to make the CS resilient to generated forces to which the CS is exposed.

The inventors have recognized and appreciated there is a need for bracing or otherwise mechanically stabilizing the CS to make the CS resilient to such generated forces while also allowing a CS and CS retaining structure to be assembled in a space defined by a plurality of assembled TF coils (referred to as a “TF coil assembly”). As illustrated in FIG. 1A (and as conceptually illustrated in FIGS. 1D, 1E), a TF coil assembly comprises an arrangement of TF coils (and disposed in coil cases 19 as illustrated in FIGS. 1D,1E) structurally coupled so as to form an open space in a center thereof in which a CS 12 may be disposed. The inventors have also recognized that in embodiments, it may be advantageous to first assemble a plurality of TF coils so as to form the TF coil assembly and subsequently install a CS 12 in the preassembled TF coil assembly. Such an assembly approach, allows replacement of a CS without taking apart a TF coil assembly.

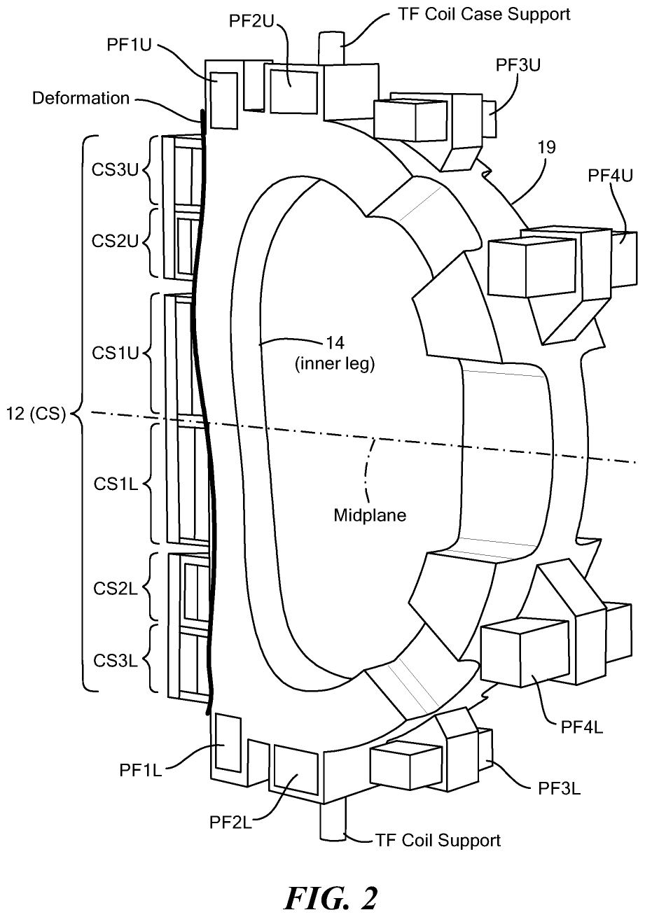

As illustrated in FIG. 1A (and FIG. 2), the TF coils 13 each may have a D-shape. Other shapes may, of course, also be used. The body of the TF coils 13 may be formed from a conductive metal, often in the form of a baseplate having one or more superconducting current paths formed from HTS tape within the baseplate. The HTS tape may wind around the body of the baseplate one or more times. Electric current is provided to the HTS coil 13 to generate a high-strength magnetic field. The conducting channel through the baseplate may also have (in addition to the HTS tape) a conductive material (sometimes referred to as a “co-wind”) disposed therein. In some embodiments, a conductor may be disposed over the HTS as a cap. According to some embodiments, the HTS may comprise a rare earth barium copper oxide superconductor (REBCO), such as yttrium barium copper oxide (YBCO). In some embodiments, the HTS coils 13 may include a plurality of layers of windings arranged in a stack. In this arrangement, each layer of windings may be referred to as a “pancake” and the stacked plurality of layers of windings may be referred to as a “stack of pancakes.”

In some embodiments, the inner legs 14 of the TF coils 13 may be designed to press up against (or contact) one another when they are energized, as shown in FIG. 1E (a so-called “bucked” design).

The inventors have also recognized and appreciated the need to handle large forces that can arise in a tokamak reactor. For example, high magnetic field strengths lead to large Lorentz forces on the conductors. Although forming magnets in high-strength metal structures may stabilize the conductors in the presence of a static field, the inventors have recognized and appreciated that transient events in the tokamak may produce large asymmetric forces on the TF coils 13. One example of such a transient event is a so-called “tsunami” quench that propagates inductively around the tokamak. In a tsunami quench, the transition of one TF coil from a superconducting state to a non-superconducting state produces a change in the magnetic field that affects a neighboring TF coil, causing it to quench, which may, in turn, cause its neighboring TF coil to quench, and the process may continue around the circumference of the tokamak in a quench “tsunami.” Another example of a transient event is the during the “shot” in which plasma is formed in the vacuum vessel 11.

Interaction between the time-varying magnetic fields produced by the central solenoid (CS) 12 with the currents of the TF coils 13 may create so-called out-of-plane (OOP) forces, tending to deform the inner leg 14 of the TF coil (i.e. the portion of the TF coil closest to the CS 12) in the circumferential direction, tangentially to the cylindrical interface between the inner leg 14 inner surface and the CS 12 outer surface. An example of such deformation is depicted in FIG. 2.

In short, certain events can produce large asymmetric forces on the TF coils 13 which may cause them to bend and/or twist from their nominal in-plane shape. Thus, the TF coils may be braced or otherwise mechanically stabilized to make them resilient to transient events.

During operation of the TF coils 13, their magnetic fields produce forces that push the TF 13 coils toward the center of the tokamak. These forces may be dealt with by using different approaches. One technique is termed “wedging” and may be referred to as a “wedged” design. In a wedged design the TF coils 13 are designed to press up against one another (e.g., at least some portions have physical contact with one another) as they press toward the interior of the tokamak, which distributes forces from one TF coil to another, in the circumferential direction of the tokamak. Another technique is termed “bucking” and may be referred to as a bucked design. In a bucked design the TF coils press up against (e.g., at least some portions have physical contact with) a central structure of the tokamak, such as the CS. The two techniques are not mutually exclusive, and some designs rely on a combination of both techniques, which may distribute forces circumferentially and radially in different proportions depending on the design.

The inventors have recognized and appreciated that a primarily “bucked” design is preferable for creating a small tokamak reactor, for a number of reasons. First, a primarily bucked design distributes forces toward the center of the tokamak, away from the winding pack of the TF coils, which helps to avoid strain on the winding pack. Second, a primarily bucked design may serve a secondary purpose, which is to counter the expansion forces produced by the central solenoid. A primarily bucked design helps to avoid the need for a containment structure to absorb the expansion forces produced by the central solenoid, which helps in keeping the size of the tokamak small.

FIGS. 1B and 1C illustrate a portion (e.g. one-quarter) of a tokamak fusion reactor which may be the similar in some respects to the tokamak fusion reactor shown in FIG. 1A. It should be noted that in FIGS. 1B, 1C only portions of TF coil assemblies and CS assemblies are shown.

TF coils may each include one or more layers of windings (not visible in FIGS. 1A-1E) extending through the inner legs 14. The one or more layers of windings may be encased in (or disposed in) a structural case (referred to herein as a TF coil case 19) examples of which may be most clearly viewed in FIGS. 1B, 1C and FIG. 2). A CS retaining structure 15 comprises one or more locking structures (generally referred to as “detents”) configured to engage one or more structures in one or more TF coil cases to secure (or lock) the CS retaining ring to the TF coil case. For example, one or more CS retaining structure detents may be inserted or otherwise engage recesses in one or more TF cases. The particular manner in which to provide the CS retaining structure (e.g. number of plates, size, shape and number of detents) is selected to suit the needs of the particular application.

As schematically illustrated in FIGS. 1D, 1E, the plurality of TF coils 13 are disposed within respective TF coil cases 19 and disposed around the central solenoid (CS) 12 with at least portions of inner legs 14 contacting one another and contacting portions of CS 12 as shown in FIG. 1E.

FIG. 1D is a schematic diagram of a top view of a tokamak fusion reactor having a bucked design when the TF coils are not energized. As shown in FIG. 1D, when the TF coils are not energized, inner legs 14 of the TF coils are spaced apart from one another and from the CS 12.

FIG. 1E is a schematic of a top view of a bucked design tokamak fusion reactor when the TF coils 14 are energized. Surfaces of inner legs 14 primarily press up against surfaces of CS 12 and may or may not also press against each other as they move inward toward the CS 12.

Between surfaces of adjacent TF coil cases 19 is a TF-to-TF interface 30 (with interface 30 illustrated as a gap in FIG. 1D). Between a surface of the inner leg 14 of a TF coil and a surface of the CS 12 is a TF-to-CS interface 32 at an inner side of the inner leg 14 (with interface 32 illustrated as a gap in FIG. 1D). In embodiments, the TF-to-TF interface 30 and the TF-to-CS interface 32 (FIG. 1D) may have an electrically insulating material disposed therein insulating the TF coils 13 from one another and from the CS 12. Such insulation may impede (and ideally, prevent) formation of eddy currents which may lead to excess heating.

As mentioned above, the inventors have recognized and appreciated there is a need for bracing or otherwise mechanically stabilizing the CS to make the CS resilient to forces generated. As noted above, in some embodiments, the inner legs 14 of the TF coils 13 may be designed to press up against one another (e.g. physically contact one another or the electrically insulating material disposed between insulating the TF coils 13 may contact one another) when the coils are energized, as shown in FIG. 1E (the so-called bucked design).

In a bucked design TF magnets operate with toroidal gaps between them (with the gaps being in the range of about 0.5 mm to about 2 mm with a gap of 1 mm being preferred in some embodiments) and are constrained radially by backpressure at the cylindrical interface between the inner legs of the TF magnets and the outer diameter (OD) of the CS.

Referring now to FIG. 2, as illustrated, TF coils are disposed in a TF coil case 19. In the example embodiment of FIG. 2, the CS is comprised of an upper set of CS modules and a lower set of CS modules with each set comprising one or more modules. In the example embodiment of FIG. 2, the CS comprises six (6) central solenoidal modules with the upper set and lower set each comprising three modules. In FIG. 2, the upper set of CS modules are designated CS1U, CS2U, CS3U and the lower set of CS modules are designated CS1L, CS2L, CS3L. The upper and lower sets of CS modules are symmetrically arranged about a mid-plane of the TF coils.

It should be noted that in FIG. 2, reference numerals 1-2-3 (e.g. CS1U, CS2U, CS3U) are assigned to CS modules from the mid-plane out. That is, in the upper CS module, CS1U is closest to the midplane and CS3U is furthest from the midplane as illustrated in FIG. 2. Similarly, in the lower CS module, CS1L is closest to the midplane and CS3L is furthest from the midplane as also illustrated in FIG. 2.

Also shown in FIG. 2 are upper and lower PF coils. In this example embodiment there are 4 upper PF coils (PF1U-PF4U) and 4 lower PF coils (PF1L-PF4L) for a total of 8 PF coils in this example embodiment. Also illustrated in FIG. 2 is a TF coil support (also sometimes referred to as a “pin”). This example embodiment includes upper and lower TF coil supports but other embodiments may include only a bottom support or only a top support.

Each of the CS modules may be coupled to an individual power supply (PS) and during the plasma operation current supplied to each CS module is driven in time by its individual scenario (i.e., current versus time scenarios). In some scenarios, pairs of symmetrically arranged CS modules (e.g., CS1U-CS1L, CS2U-CS2L, CS3U-CS3L), are substantially the same. In some rare scenarios they may differ.

During normal operation (with normal operation defined by current vs time scenario during a plasma shot) there is typically substantially no net force on the stack of CS coils comprising the CS. The exception is a relatively small axial force during a very short asymmetric plasma disruption. Disregarding this exception, if currents in all CS modules are such that their magnetic dipoles are in the same direction, CS modules attract to each other. Together with the zero net force this means that the CS stack may be supported axially (i.e., in a direction along a central longitudinal axis) only against its relatively small (compared with the electromagnetic (EM) forces) gravitational force, i.e., its weight. A CS retaining structure may serve this purpose.

During a plasma shot, currents in different pairs of symmetrical modules change their signs and so do the directions of their magnetic dipoles. At some points of the operation scenario EM forces on the outermost modules, CS3U and CS3L or the sum of forces on a pair of them CS3U+CS2U and CS3L+CS2L are directed away from the mid-plane. These axial forces are quite substantial, up to 40-60 MN. Such forces may be sufficient to cause the outermost CS coils to be propelled with such force that they are ejected from the tokamak if not adequately secured. The CS retaining structures described herein are capable of securing the outermost CS coils during the significant forces produced during a plasma shot. A tokamak may include a first CS retaining structure over the top of the CS module (e.g., CS3U) and a second CS retaining structure below the bottom CS module (e.g., CS3L) to secure at least the top and bottom CS modules. A CS retaining structure includes at least one structural member, wherein a portion of the at least one structural member is configured to be inserted into a plurality of recesses of a plurality of toroidal field coil case structures, respectively. As discussed further below, the at least one structure member may include one or more plates or rings, for example.

FIG. 2 illustrates exaggerated deformations of the CS and TF structures at a point in time when pairs of modules, CS3U+CS2U and CS3L+CS2L, tend to move outwards. Launching forces on outermost CS modules can happen at any time, even when TF out-of-plane deformations are insignificantly small.

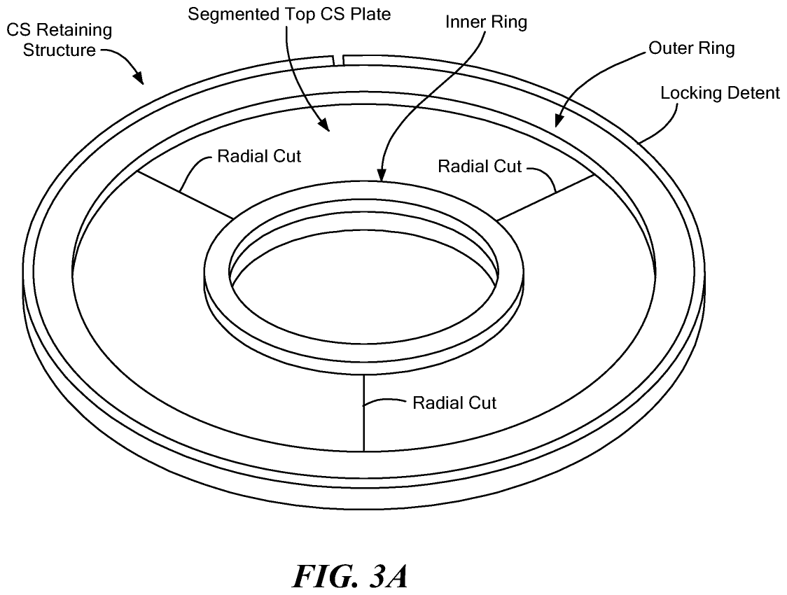

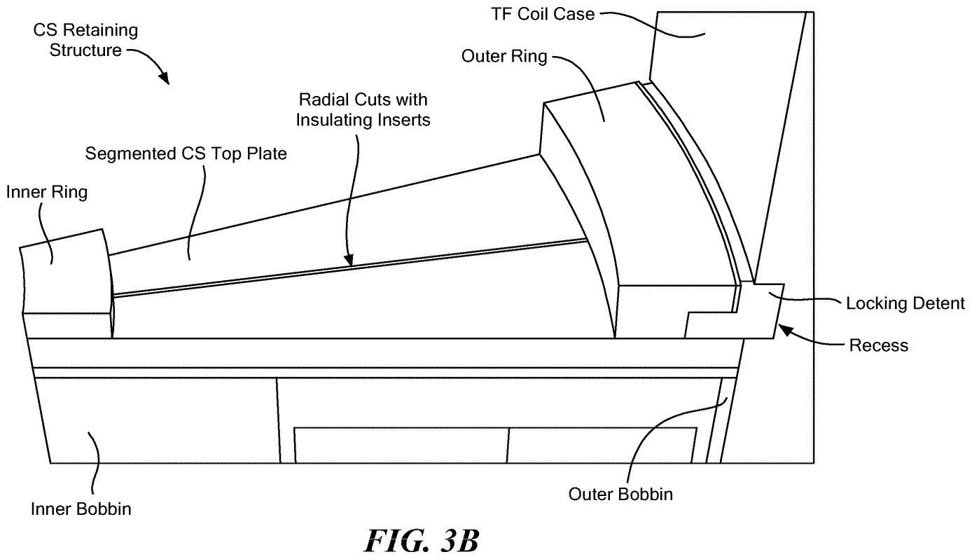

FIGS. 3A, 3B illustrate a first embodiment of a CS retaining structure comprising an outer ring having a locking detent structure (configured to engage with a locking groove or recess of a TF coil case) and an inner ring coupled to a top CS plate. Such a CS retaining structure may be used to secure a CS in a tokamak fusion reactor by insertion of the locking detent structure into a recess of a TF coil case.

As can be seen in FIGS. 3A, 3B the locking detent is provided on a top portion or a top surface of the top CS plate. In embodiments, the top CS plate may comprise a plurality of segments joined to form the top CS plate and this is sometimes referred to herein as a “segmented CS plate.” Segmenting the top structural plate may mitigate (or ideally eliminate) eddy-current heating of the structural plate. In the example embodiment of FIG. 3A, the structural plate is segmented azimuthally with radial openings (also referred to as radial cuts, spaces, gaps, recesses, etc.) into which insulation may be disposed (i.e., materials or structures which are substantially an electrical insulator may be disposed in all or portions of the openings provided in the structural plate). Such openings with insulation disposed therein are sometimes referred to herein as “insulated cuts.”

As can be seen in FIG. 3B, the locking detent may be provided a part of an insert structure and the locking detent is disposed in a recess (or cutout) portion of a TF coil case. The CS retaining structure design of FIG. 3A may utilize fifteen (15) parts, but the CS retaining structures described herein are not limited as to the number of parts. In embodiments, a system utilizing a CS retaining structure such as that shown in FIGS. 3A, 3B may comprise eighteen (18) inserts each of which comprises a locking detent configured to be disposed in a recess of each of eighteen TF coil cases of the tokamak. However, this is by way of example, and the number of TF coil cases and inserts may be different from eighteen. The inserts are coupled to the outer ring which is disposed on and coupled to a surface of a segmented CS structural top plate (in this example, the insert is disposed under a cutout portion of the outer ring).

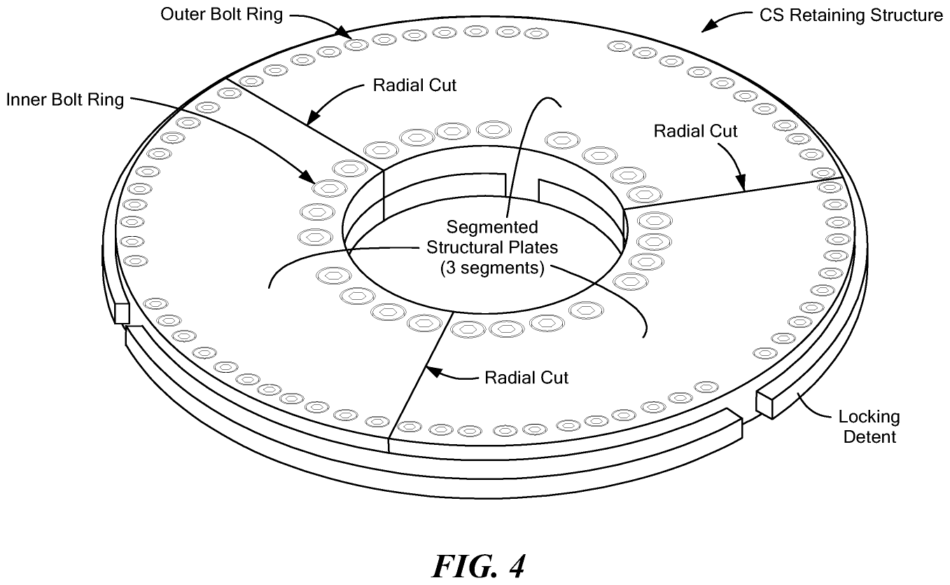

FIG. 4 illustrates a second embodiment of a CS retaining structure having a locking groove in a bottom region thereof. In this embodiment, the CS retaining structure comprises two plates that are bolted together via inner and outer bolt rings. One feature of this CS retaining structure embodiment is that it comprises a strong structural plate, installed or otherwise disposed on a surface (e.g., a “top” surface) of an outermost portion of the CS (e.g., on an outermost portion of the CS3 module illustrated in FIGS. 1B and 2). In FIG. 4, the strong structural plate is illustrated as the top plate and the bottom plate which is coupled to the top plate includes one or more detents.

For reasons which will be explained below, the top and bottom plates may each be segmented into a plurality of segments. In the example embodiment of FIG. 4, the top and bottom plates are each provided having three segments for a total of 6 parts. Since the segments of the top plate are the same and the segments of the bottom plate are the same, there are two unique parts.

The strong structural plate (i.e., the top plate in FIG. 4) is secured and supported axially by the locking detents. Radially, locking detents sit freely in grooves/recesses in TF cases (not shown in FIG. 4) held in position by TF wedging forces. The locking detent is configured (e.g. provided having a size and shape) to be disposed in one or more recesses in the TF coil case (not shown in FIG. 4).

In embodiments, the structural plate may be segmented to mitigate eddy-current heating of the structural plate. In the example embodiment of FIG. 3A, the structural plate is segmented azimuthally with three (3) radial openings (e.g., cuts, spaces, gaps, recesses) provided in the structural plate. Insulation (i.e., materials or structures which are substantially an electrical insulator) may be disposed in all or portions of the openings. The openings with insulation disposed therein are sometimes referred to herein as “insulated cuts.”

These insulated cuts may reduce structural stiffness of the structural plate. Thus, to maintain structural integrity of the CS retaining structure, inner and outer bolt rings may be secured to the structural plate. In embodiments, a detent region of the structural plate may be inserted into recesses in the TF coil case and thus also serve to provide radial and/or axial support of the elements comprising the CS (e.g., the cylindrically shaped CS modules described in conjunction with FIGS. 1B, 2).

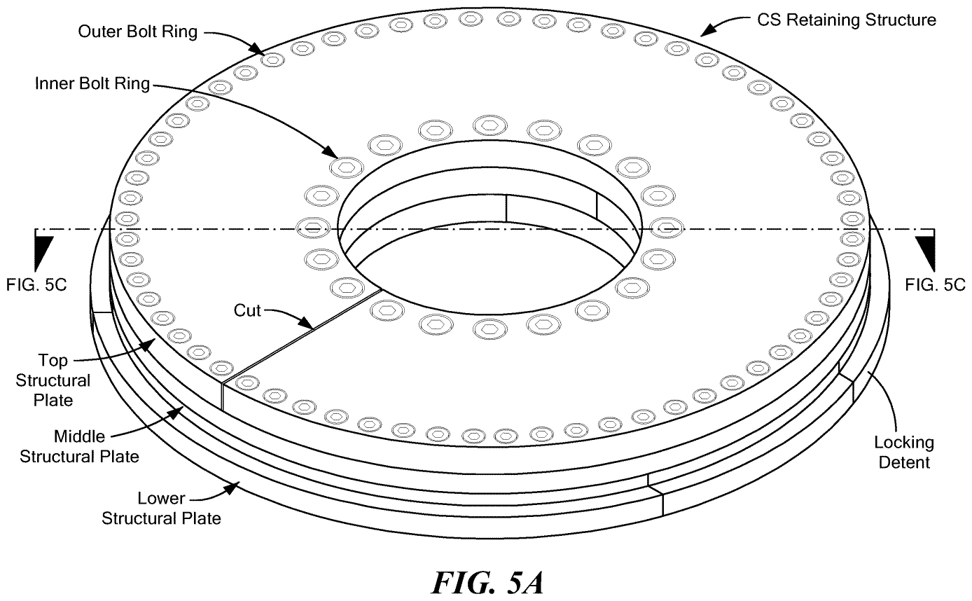

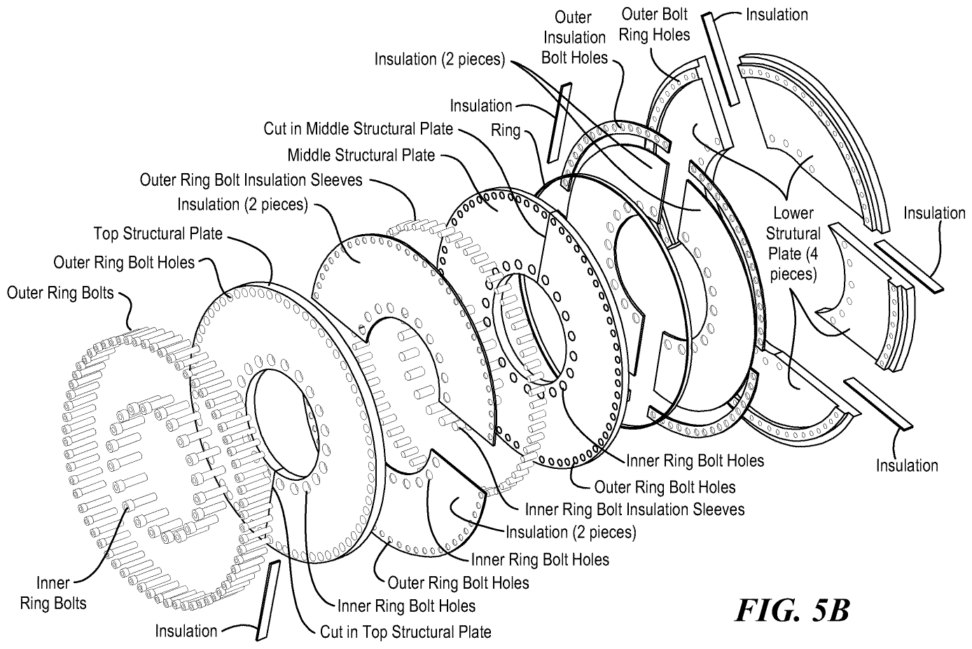

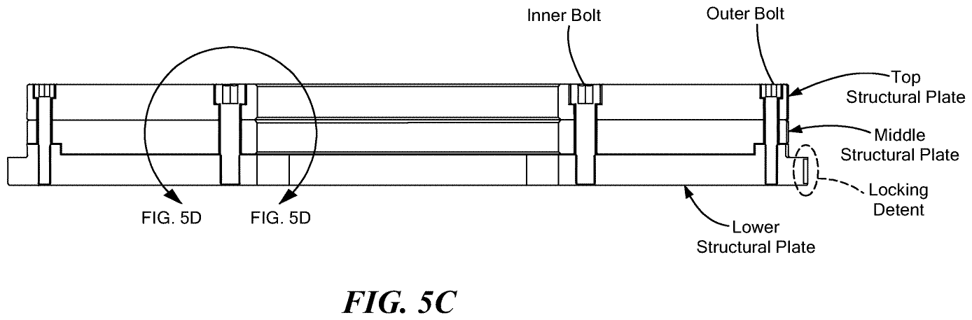

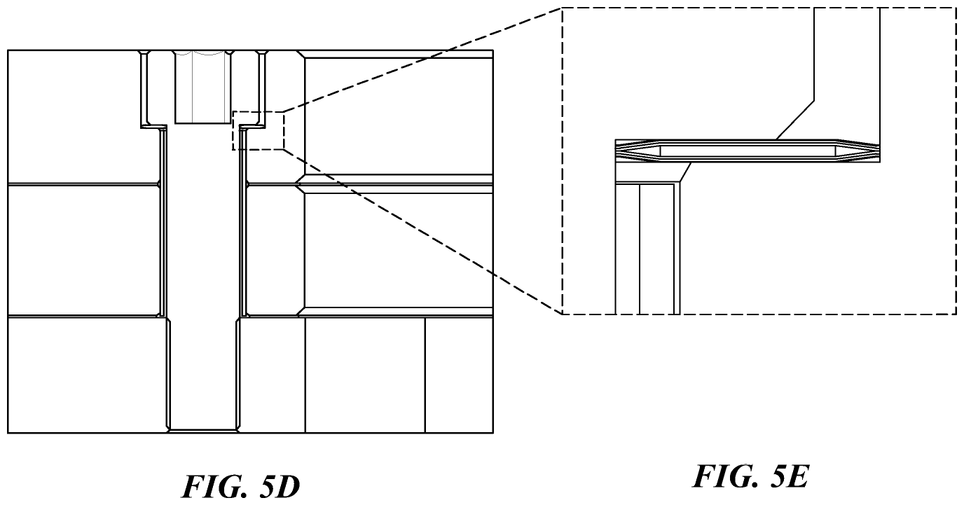

Referring now to FIGS. 5A-5E in which like elements are provided having like naming and/or like reference designations throughout the several views, a third embodiment of a CS retaining structure comprises a plurality of structural plates, here three (3), structural plates. In embodiments, CS retaining structure may comprise fewer or more than three structural plates. In the example embodiment of FIGS. 5A-5E, the three structural plates are designated as a top structural plate, a middle structural plate and a lower structural plate. The structural plates may be secured together via fasteners or any other means having sufficient mechanical integrity. In the example embodiment of FIG. 5A, 5B the structural plates are bolted together via a series of inner and outer bolt rings.

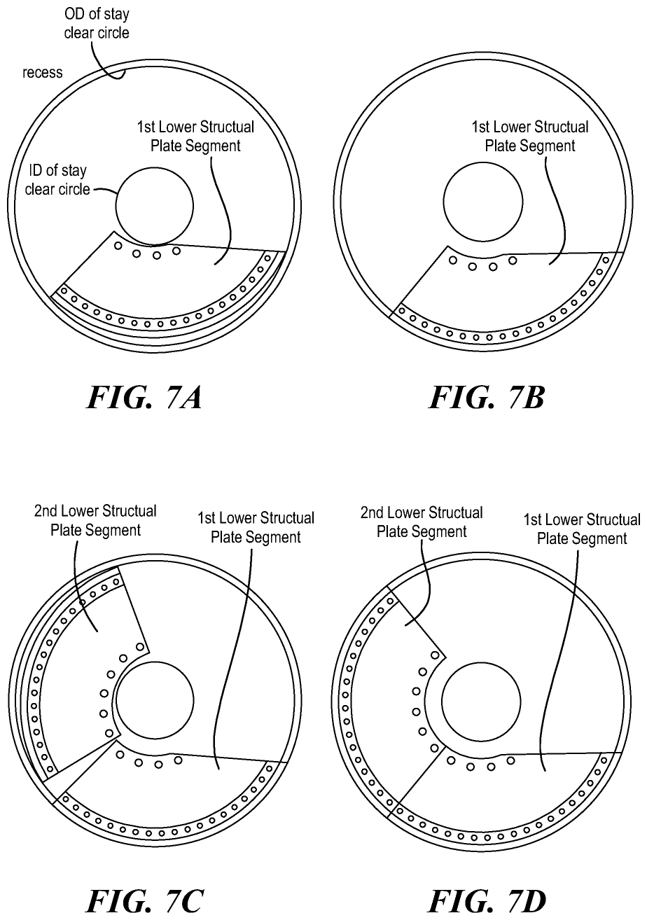

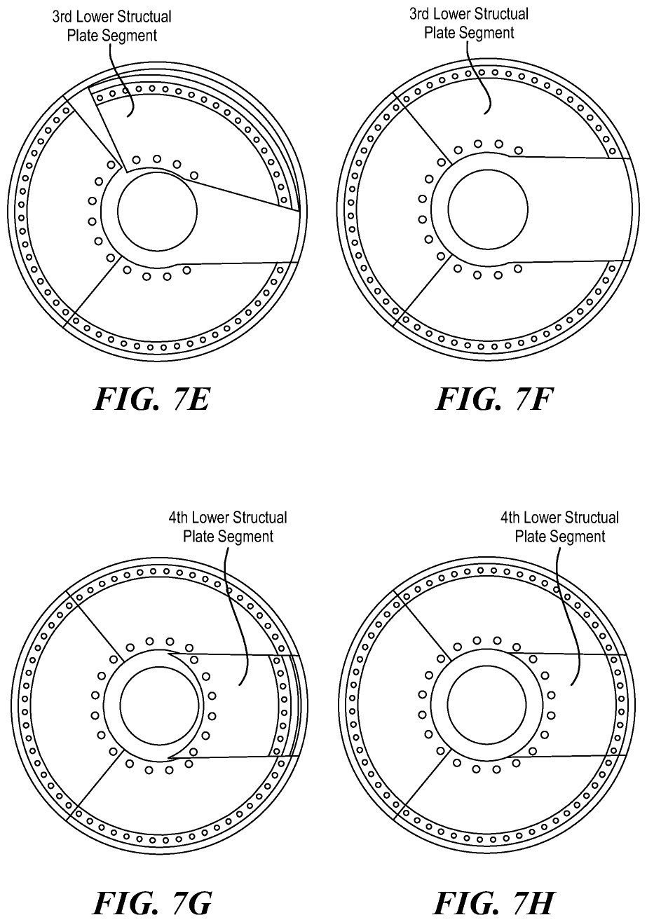

As may be most clearly seen in FIG. 5B, the lower structural plate comprises a plurality of segments, here four (4), segments, having shapes selected to permit, and ideally facilitate, insertion of outer portions of the segments into one or more recesses provided in a TF coil assembly (e.g. such as the recess illustrated in FIG. 3B), as will be described below in conjunction with FIGS. 7A-7H.

In embodiments, the middle and top structural plates may be substantially identical. However, this is an example, and the middle and top structural plates may not be substantially identical. As also shown in FIGS. 5A, 5B, the middle and top structural plates may be segmented with one or more openings. Such openings in the structural plates may mitigate eddy-currents and resultant heating of the structural plates. In the example embodiment of FIG. 5A, the middle and top structural plates may be segmented azimuthally with one or more radial openings (e.g., cuts, spaces, gaps, recesses, etc.) into which insulation may be disposed. That is, materials or structures which are substantially an electrical insulator may be disposed in all or portions of the openings provided in the structural plate. As noted above, such openings with insulation disposed therein are sometimes referred to herein as “insulated cuts.”

The middle and top structural plates are arranged so that the openings (or cuts) are not aligned. In embodiments, the middle and top structural plates are arranged so that the openings are opposite to each other to thereby reduce, and ideally minimize, any structural weakening of the bending stiffness of the plates resultant from the radial openings. Such an arrangement may be seen in FIG. 5B where the “cut” in the top structural plate is spaced 180 degrees from the cut in the middle structural plate.

Since voltages may result from eddy currents, insulation may be disposed between structural plates. Since such induced voltages are relatively low, a low voltage insulation may be disposed between the structural plates. Such insulation may impede the formation of eddy currents which may lead to excess heating. In embodiments, the insulating material may comprise a polymer material, such as a polyimide material, but is not limited to polyimide or polymer materials. Insulation between the surfaces of two or more structural plates bolted together parts does not experience substantial friction and thus may be made of G10 or G11 material, for example.

Interfaces between surfaces of the CS retaining structure and the TF coil cases (e.g., interface 32 in FIG. 1D), however, may be subject to substantial friction. Thus, insulation disposed between surfaces of the CS retaining structure and the TF coil cases, are preferably provided from one or more materials which provide a structurally robust insulator and is substantially resilient to the friction-related damage. The insulating material disposed between surfaces of the CS and TF coil case (i.e., the CS-TF interface) may, for example, comprise a polymer material, such as a polyimide material, but is not limited to polyimide or polymer materials. For example, the insulating material may comprise an anodized metal such as an anodized metallic sheet, for example. Since the insulating material may be subject to significant grinding and crushing forces, in some embodiments an interface structure may also comprise one or more (non-anodized) metal materials such as metal sheets. In embodiments the insulating material and metal material may be laminated so as to provide a CS-TF interface insulator structure as a laminated insulation.

FIGS. 5D, 5E illustrate insulation disposed between the bolts and the plates to reduce eddy currents.

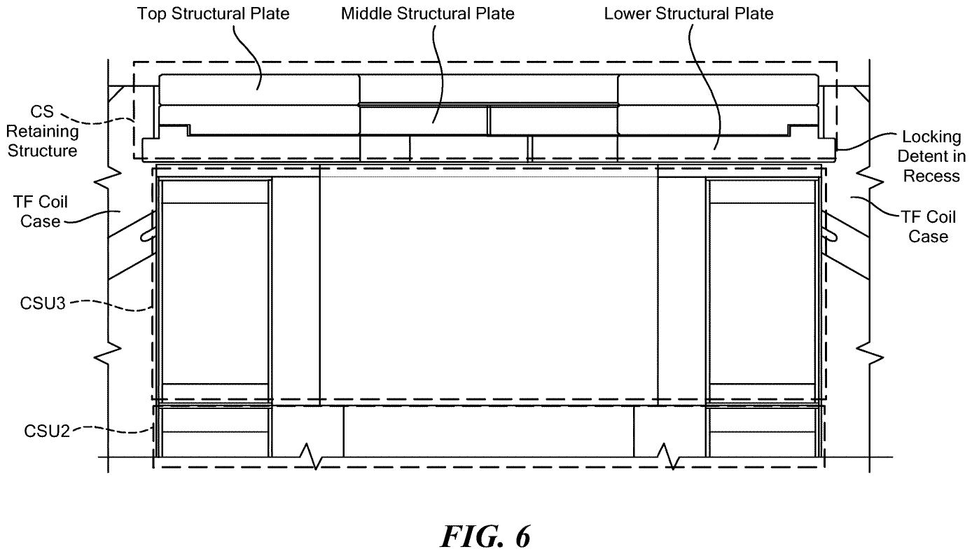

Referring now to FIG. 6, a CS retaining structure which may be the same as or similar to the CS retaining structure described above in conjunction with FIGS. 5A-5E, is disposed or installed above a CS module (here, identified as the CS3U CS module) inside a TF coil assembly which may comprise several individual TF coil cases. It should, of course, be appreciated that the same retaining structure may also be installed under CS3L. The CS retaining structure comprises a top structural plate, a middle structural plate and a lower structural plate having locking detents configured to engage or mate with one or more recesses provided in one or more TF coil cases.

Referring now to FIGS. 7A-7H, shown is a method for assembling a lower structural plate within a TF coil assembly after the central solenoid has been installed. The method shown in FIGS. 7A-7H may be reversed to disassemble the lower structural plate within the TF coil assembly, thereby providing access to the central solenoid for removal and servicing while the TF coil assembly remains intact. The lower structural plate is comprised of a plurality of segments within a TF coil assembly. The lower structural plate segments are configured to allow insertion of a detent region into a recess in a TF coil assembly. In the example embodiment of FIGS. 7A-7H, the lower structural plate comprises a plurality of segment, here four (4) segments. As noted above, it should be appreciated that in other embodiments, the lower structural plate may comprise fewer or more than four pieces. It should be appreciated that in some embodiments (for at least manufacturing reasons) it may be desirable to have as few unique parts as possible, while still allowing insertion into the TF recess groove, assuming TF coils are already in their radially converged, as shown in FIG. 1E, position.

Several geometric boundaries are shown in FIGS. 7A-7H. Assembly of the lower structural plate avoids two “stay clear” circles, one on an inside diameter (“ID”) of the plate and one on an outside diameter (“OD”) of the plate. The ID stay clear circle represents the outside boundary of a volume containing various components that should not be disturbed during assembly of the lower structural plate. The OD stay clear circle represents an inside diameter of the TF coil assembly. Also shown is a recess in the TF coil assembly into which detents on the lower structural plate are inserted to provide mechanical resistance against movement of the CS modules. Although shown as a single recess for purposes of illustration, each of the TF coil cases may be separate structures and have their own respective recesses that are aligned with one another.

As shown in FIG. 7A, the method begins by inserting a first segment of a lower structural plate into a space formed by a TF coil assembly. The first segment of the lower structural plate has a shape such that when it is inserted into the space formed by the TF coil assembly, as shown in FIG. 7A, it does not enter either the ID or OD stay clear circles. A shown in FIG. 7B, the first segment is then slid (or pushed or rotated) into a recess (or cut out region) of the TF coil assembly. Insulation may be placed on one or more surfaces of the first segment, as shown in FIG. 5B, either before or after the first segment is inserted.

Next as shown in FIG. 7C, a second segment of a lower structural plate is inserted into the space formed by the TF coil assembly. The second segment of the lower structural plate has a shape such that when it is fully inserted, as shown in FIG. 7C, it avoids both the ID and OD stay clear circles. A shown in FIG. 7D, the second segment is then slid (or pushed or rotated) into the recess (or cut out region) of the TF coil case and moved adjacent the first segment. Insulation may be placed on one or more surfaces of the second segment, as shown in FIG. 5B, either before or after the second segment is inserted but before the first and second segments are locked into their final positions.

As shown in FIGS. 7E-7H, this process continues for the remaining two lower structural plate segments. Once all segments of the lower structural plate are inserted (thereby completing the lower structural plate) the remaining structures of the CS retaining structure (e.g., as shown in FIG. 5B) may be disposed over the lower structural plate and bolted together via inner and outer ring bolts (e.g. as shown in FIG. 5B). Relative movement of the segments of the lower structural plate, and relative movement of the plates of the CS retaining structure with respect to each other, are substantially prevented by the bolts.

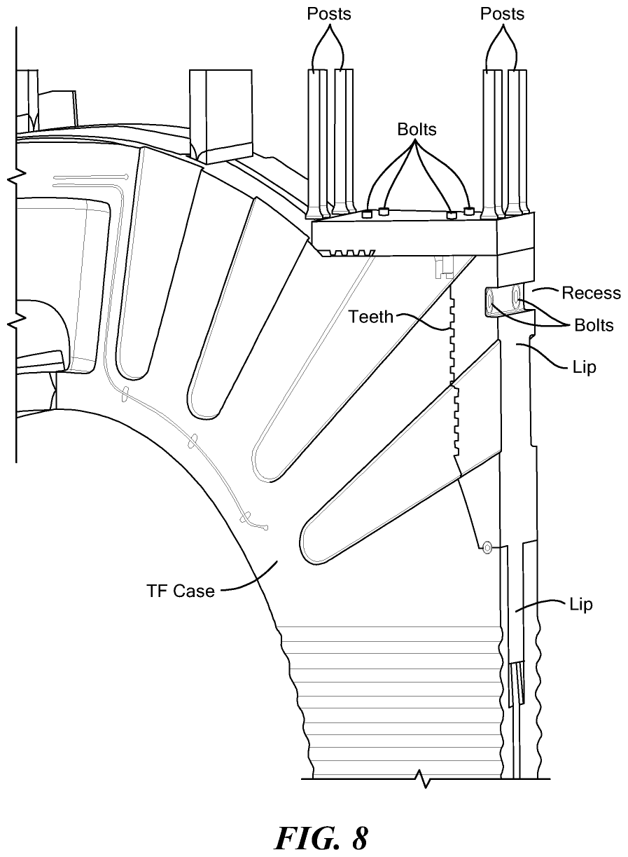

Referring now to FIG. 8, contact pressure between the top plate of the CS, inserted in the recess of a TF coil, and the material in the recess region of the TF coil is substantial and defines the need for good structural properties. In embodiments, an insert 802 may be added to the TF coil. Insert 802 may be bolted or otherwise secured to the TF case (for example, using bolts on the top of the insert 802 and bolts through the recess of the insert 802). Insert 802 includes a locking structure (here illustrated as a series of teeth which mate to teeth in the TF case) and a detent (or “lip” structure) extending from one end of the insert (here a bottom of the insert 802). The lip is provided having a size and shape selected to azimuthally secured insert 802 to the TF case. Insert 802 may be provided from non-magnetic steel or Nitronic 40 or 50. Other materials having strength characteristics the same as or better than steel or Nitronic 40 or 50 may also be used.

In embodiments, an insert which may be the same as or similar to insert 802 may be included proximate PF1 located closer to a central longitudinal axis of the tokamak.

In other embodiments no insert 802 is included, and the detent may be inserted directly into a recess in the TF coil case itself.

The structures described herein may be formed of various materials. In some embodiments, some or all components of the CS retaining structure may be formed of steel. For example, the structural plates, rings and/or bolts may be formed of steel. The recesses into which the locking detent is inserted may have sides formed of steel (e.g., as a TC coil case or insert). However, the present disclosure is not limited to structural materials being formed of steel, as another material may be substituted having suitable strength.

Furthermore, as described above, CS retaining structures comprising one or more detents configured to engage, mate or otherwise couple to one or more structures in one or more TF coil cases may be provided from one or more plates (a plurality of plates with one or more of the plurality of plates having detents. Furthermore, the one or more plates may or may not be segmented. The particular design of the CS retaining structure (e.g. number of plates, size, shape and number of detents) may be selected to suit the needs of the particular application.

Various embodiments of the concepts, systems, devices, structures and techniques sought to be protected are described herein with reference to the related drawings. Alternative embodiments can be devised without departing from the scope of the concepts, systems, devices, structures and techniques described herein. It is noted that various connections and positional relationships (e.g., over, below, adjacent, etc.) are set forth between elements in the following description and in the drawings. These connections and/or positional relationships, unless specified otherwise, can be direct or indirect, and the described concepts, systems, devices, structures and techniques are not intended to be limiting in this respect. Accordingly, a coupling of entities can refer to either a direct or an indirect coupling, and a positional relationship between entities can be a direct or indirect positional relationship.

As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s). The following definitions and abbreviations are to be used for the interpretation of the claims and the specification. As used herein, the terms “comprises,” “comprising, “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance, or illustration. Any embodiment or design described herein as “exemplary” is not necessarily to be construed as preferred or advantageous over other embodiments or designs. The terms “one or more” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection”.

References in the specification to “one embodiment, “an embodiment,” “an example embodiment,” etc., indicate that the embodiment described can include a particular feature, structure, or characteristic, but every embodiment can include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal, “top,” “bottom,” and derivatives thereof shall relate to the described structures and methods, as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements. It should be noted that the term “selective to, “such as, for example, “a first element selective to a second element,” means that the first element can be etched and the second element can act as an etch stop.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. (canceled)

2. A CS retaining structure comprising:
a lower structure plate having first and second surfaces and having a locking detent having a shape configured to engage a recess provided in a TF coil case;
a middle structural plate having first and second opposing surfaces with a first one of the first and second opposing surfaces of the middle structural plate disposed over a first one of the first and second surfaces of the lower structural plate and the middle structural plate having at least one cut provided therein;
a top structural plate having first and second opposing surfaces with a first one of the of the first and second surfaces of the top structural plate disposed over a second one of the first and second surfaces of the middle structural plate and the top structural plate having at least one cut provided therein; and
fasteners disposed to secure together the top, middle and lower structural plates.

3. The CS retaining structure of claim 2 wherein the lower structural plate comprising a plurality of segments, each segment having a shaped selected to permit insertion of the lower structural plate segments into one or more recess provided in a TF coil assembly.

4. The CS retaining structure of claim 2 wherein the top, middle and lower structural plates are bolted together via a series of inner and out ring bolts.

5. A CS retaining structure comprising a lower structural plate having first and second opposing surfaces and having a locking detent having a shape configured to engage a recess provided in a TF coil case, wherein the lower structural plate comprises four (4) segments.

6. The CS retaining structure of claim 2 wherein the middle and top structural plates are substantially identical.

7. The CS retaining structure of claim 2 wherein:
the middle structural plates is segmented azimuthally with one or more radial cuts; and
the top structural plate is segmented azimuthally with one or more radial cuts.

8. The CS retaining structure of claim 2 further comprising insulation disposed in each of the one or more radial cuts provided in the middle and top structural plates.

9. The CS retaining structure of claim 8 wherein the middle and top structural plates are arranged such that the one or more radial cuts in the middle structural plate are not aligned with the one or more radial cuts in the top structural plate.

10. The CS retaining structure of claim 8 wherein:
the middle structural plate has one radial cut;
the top structural plates has one radial cut; and
the middle and top structural plates are arranged such that radial cut in the middle structural plate is not aligned with radial cut in the top structural plate.

11. The CS retaining structure of claim 10 wherein the middle and top structural plates are arranged such that the radial cut in the top structural plate is spaced 180 degrees from the radial cut in the middle structural plate.

12. The CS retaining structure of claim 2 further comprising:
insulation disposed between the first one of the first and second opposing surfaces of the middle structural plate and the first one of the first and second surfaces of the lower structural plate; and
insulation disposed between the second one of the first and second opposing surfaces of the middle structural plate and the first one of the first and second surfaces of the top structural plate.

13. A tokamak fusion reactor comprising:
a TF assembly comprising a plurality of D-shaped TF coils arrange to form a space configured to accept a CS assembly;
a CS assembly having a first end and a second end, the CS assembly disposed in the space defined by the TF assembly; and
a first CS retaining structure coupled to the first end of the CS assembly, the first CS retaining structure comprising:
a lower structural plate having first and second opposing surfaces and having a locking detent having a shape configured to engage a recess provided in a TF coil case;
a middle structural plate having first and second opposing surfaces with a first one of the first and second opposing surfaces of the middle structural plate disposed over a first one of the first and second surfaces of the lower structural plate and the middle structural plate having at least one cut provided therein;
a top structural plate having first and second opposing surfaces with a first one of the of the first and second surfaces of the top structural plate disposed over a second one of the first and second surfaces of the middle structural plate and the top structural plate having at least one cut provided therein;
fasteners disposed to secure together the top, middle and lower structural plates.

14. The tokamak fusion reactor of claim 13 further comprising a second CS retaining structure coupled to the second end of the CS assembly, the second CS retaining structure comprising:
a lower structural plate having first and second opposing surfaces and having a locking detent having a shape configured to engage a recess provided in a TF coil case;
a middle structural plate having first and second opposing surfaces with a first one of the first and second opposing surfaces of the middle structural plate disposed over a first one of the first and second surfaces of the lower structural plate and the middle structural plate having at least one cut provided therein;
a top structural plate having first and second opposing surfaces with a first one of the of the first and second surfaces of the top structural plate disposed over a second one of the first and second surfaces of the middle structural plate and the top structural plate having at least one cut provided therein;
fasteners disposed to secure together the top, middle and lower structural plates.

15. The tokamak fusion reactor of claim 13 wherein the CS assembly comprises a first plurality of upper CS modules and a first plurality of lower CS modules.

16. The tokamak fusion reactor of claim 13 wherein the first CS retaining structure is disposed on one of the plurality of upper CS modules.

17. The tokamak fusion reactor of claim 13 wherein the second CS retaining structure is disposed on a one of the plurality of lower CS modules.

18-22. (canceled)

23. A retaining structure for a central solenoid of a tokamak, the retaining structure comprising:
at least one structural member, wherein a portion of the least one structural member is configured be inserted into a plurality of recesses of a toroidal coil case structures, respectively, and wherein the at least one structural member comprises a first structural member having a plurality of segments and wherein the plurality of segments are individually partially insertable into one or more recesses of the plurality of recesses.

24. The retaining structure of claim 23, further comprising at least one second structural member fastened to the first structural member.

25. The retaining structure of claim 24, wherein the at least one second structural member is bolted to the first structural member.

26. The retaining structure of claim 24, wherein the first structural member has a ring shape and the at least one second structural member has a ring shape.

27. The retaining structure of claim 24, wherein the at least one second structural member covers substantially an entire area of the first structural member outside of the plurality of recesses.

28. The retaining structure of claim 24, wherein the at least one second structural member comprises a plurality of structural members.

29. The retaining structure of claim 28, wherein the plurality of structural members have insulated cuts at different respective radial positions.

30-31. (canceled)

32. The retaining structure of claim 24, wherein the at least one structural member is between the at least one second structural member and a topmost or bottommost CS module.

33-37. (canceled)
